(19) United States
(12) Patent Application Publication
(10) Pub. No.: US 2009/0282282 A1
(43) Pub. Date: Nov. 12, 2009

(54) STORAGE APPARATUS, MEDIUM CONTAINING RETRY PROGRAM, AND RETRY METHOD

(75) Inventor: Shunsuke Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/353,011

(22) Filed: Jan. 13, 2009

(30) Foreign Application Priority Data
May 8, 2008 (JP) 2008-121885

(51) Int. Cl. G06F 11/14

(52) U.S. Cl. 714/2; 714/E11.113

(57) ABSTRACT

The storage apparatus includes a detection unit (MPU 9) that detects a recovery unit area in a storage area, an association unit (MPU 9) that associates a unit area out of recovery unit areas detected by the detection unit with a recovery parameter which is a retry parameter out of a group of a plurality of retry parameters which are ordered as correction values pertaining to the retrying, and a retry start unit (MPU 9) that starts retrying to recover the unit area that requires the predetermined time or longer for recovery by the retrying, based on a retry parameter of order determined by subtracting a predetermined number from the order of the recovery parameter associated by the association unit with the unit area that requires the predetermined time or longer for recovery by the retrying.

### CROSS-REFERENCE TO RELATED APPLICATIONS

This application is based upon and claims the benefit of priority of the prior Japanese Patent Application No. 2008-121885, filed on May 8, 2008, the entire contents of which are incorporated herein by reference.

### FIELD

The present invention relates to a recovery function of a storage apparatus.

### BACKGROUND

Conventionally, when an error occurred in an access to a storage area of a storage apparatus such as a magnetic disk drive, the storage apparatus would recover data in the error-occurring storage area (error area) by retry processing of attempting the access once again. The retry processing will be described with reference to the drawings. FIG. 8 is a diagram illustrating the head operation in the retry processing. FIG. 9 is a chart illustrating the numbers of retries and processing time for the numbers of retries.

The conventional magnetic disk drive 9 illustrated in FIG. 8 is composed of a disk medium 91 and a head 92. The retry processing refers to that when an error occurs in an access to a track that includes an area to be accessed on the disk medium 91 in the magnetic disk drive 9, the magnetic disk drive 9 makes accesses to the error area while shifting the head 92 in position with respect to the track. The magnetic disk drive 9 not only changes the position of the head 92 with respect to the track, but also alters other operations and processing. That is, the retry processing is processing that changes the condition of the magnetic disk drive 9 when accessing an error area. The retry processing changes the conditions of the magnetic disk drive 9 when making an access to the error area depending on the number of retries as illustrated in FIG. 9. For example, in FIG. 9, the amount of head offset, the value of data-correcting capability, and the presence or absence of special processing 1 and special processing 2 are changed with the number of retries.

The conventional magnetic disk drive 9 thus accesses an error area while changing the accessing conditions depending on the number of retries.

According to the retry processing described above, the time for accessing an error area (the processing time in FIG. 9) increases with the increasing number of retries. For example, assume that a host apparatus of the magnetic disk drive 9 has a designated timeout period of 1 second. If the data cannot be recovered until 300 retries as illustrated in FIG. 9, then the necessary processing time of 3 seconds produces a timeout error on the host side. This results in the problem of host hang-up.

### SUMMARY

According to an aspect of the invention, there is provided a storage apparatus for storing data in a storage area, including: a detection unit that detects a recovery unit area in the storage area, the recovery unit area being a unit area recoverable by retrying; an association unit that associates a unit area out of recovery unit areas detected by the detection unit, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and a retry start unit that starts retrying to recover the unit area that requires the predetermined time or longer for recovery by the retrying, based on a retry parameter of order determined by subtracting a predetermined number from the order of the recovery parameter associated by the association unit with the unit area that requires the predetermined time or longer for recovery by the retrying.

There is also provided a medium containing a retry program in a computer-readable fashion, the retry program being executable by a computer in a storage apparatus for storing data in a storage area, the retry program causing the computer to execute: detecting a recovery unit area in the storage area, the recovery unit area being a unit area recoverable by retrying; associating a unit area out of recovery unit areas detected in the detection, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and starting retrying to recover the unit area that requires the predetermined time or longer for recovery by the retrying, based on a retry parameter of order determined by subtracting a predetermined number from the order of the recovery parameter associated by the association with the unit area that requires the predetermined time or longer for recovery by the retry.

There is also provided a retry method of a storage apparatus for storing data in a storage area, the retry method including: detecting a recovery unit area in the storage area, the recovery unit area being a unit area recoverable by retrying; associating a unit area out of recovery unit areas detected in the detection, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and starting retrying to recover the unit area that requires the predetermined time or longer for recovery by the retrying, based on a retry parameter of order determined by subtracting a predetermined number from the order of the recovery parameter associated by the association with the unit area that requires the predetermined time or longer for recovery by the retrying.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of a HDD according to an embodiment;

FIG. 2 is a block diagram illustrating the HDD and its host apparatus according to the present embodiment;

FIG. 3 is a flowchart illustrating retry number saving processing;

FIG. 4 is a flowchart illustrating the operation of retry processing;

FIG. 5 is a flowchart illustrating the operation of normal retry processing;

FIG. 6 is a flowchart illustrating the operation of quick retry processing;

FIG. 7 is a chart illustrating the numbers of retries and processing contents for the numbers of retries;

FIG. 8 is a diagram illustrating a head operation in retry processing;

FIG. 9 is a chart illustrating the numbers of retries and processing time for the numbers of retries; and

FIG. 10 is a diagram illustrating an example of a computer system to which the present invention is applied.

### DESCRIPTION OF EMBODIMENT(S)

Hereinafter, an embodiment of the present invention will be described with reference to the drawings. It should be appreciated that while the present embodiment will deal with a magnetic disk drive (HDD) as an example of the storage apparatus, it is not intended to limit the aspect of the invention.

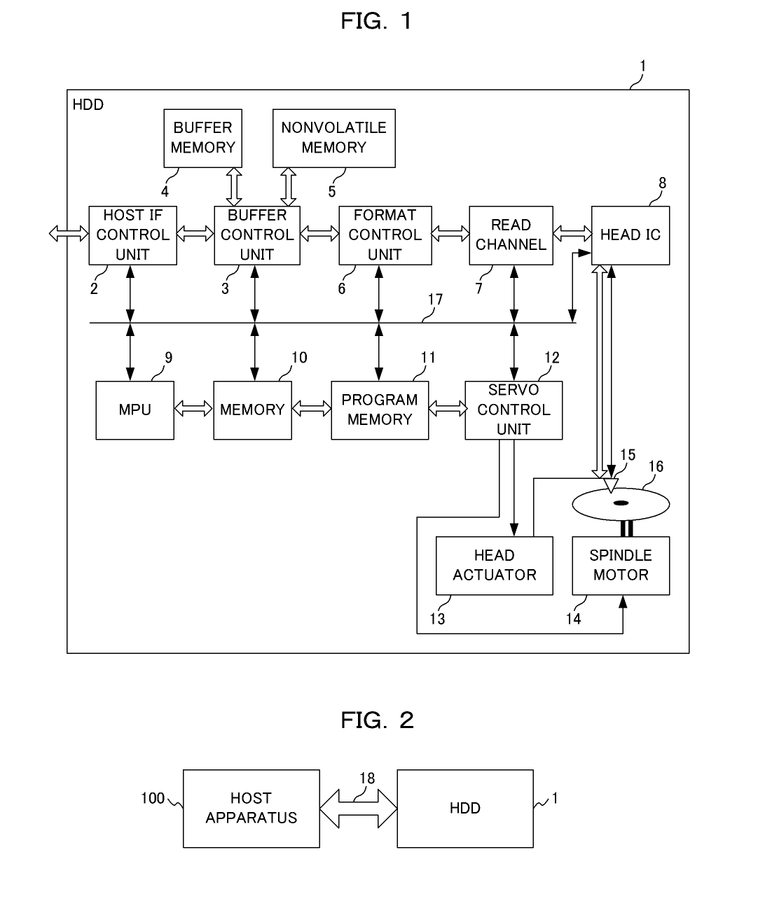

Description will initially be given of the HDD (Hard Disk Drive) according to the present embodiment. FIG. 1 is a block diagram illustrating the configuration of the HDD according to the present embodiment. FIG. 2 is a block diagram illustrating the HDD and its host apparatus according to the present embodiment.

As illustrated in FIG. 1, the HDD 1 includes a host IF (InterFace) control unit 2, a buffer control unit 3, a buffer memory 4, a nonvolatile memory 5, a format control unit 6, a read channel 7, a head IC 8, an MPU (Micro Processing Unit, detection unit, association unit, retry start unit) 9, a memory 10, a program memory 11, a servo control unit 12, a head actuator 13, a spindle motor 14, a read/write head 15, a disk medium 16 (storage area), and a common bus 17.

The host IF control unit 2 is a control circuit for controlling a host interface which is not illustrated in FIG. 1. The buffer control unit 3 is a control circuit for controlling the buffer memory 4 and the nonvolatile memory 5. The buffer memory 4 temporarily stores data which is read and written from/to the disk medium 16. The nonvolatile memory 5 stores internal information on the HDD 1. The format control unit 6 is a control circuit intended for format control. The read channel 7 demodulates and modulates data which is read and written from/to the disk medium 16 by the read/write head 15. The head IC 8 amplifies a signal that is read from the disk medium 16 by the read/write head 15. The MPU 9 performs processing pertaining to the control of the HDD 1. The memory 10 temporarily stores data and programs pertaining to the control of the HDD 1. The program memory 11 is a nonvolatile memory (FROM) which contains programs pertaining to the control of the HDD 1. The servo control unit 12 controls the operation of the head actuator 13 and the spindle motor 14. The head actuator 13 drives the read/write head 15. The spindle motor 14 rotates the disk medium 16. The read/write head 15 magnetically stores data into the disk medium 16 and reads the stored data from the same. The common bus 17 is a bus for connecting the host IF control unit 2, the buffer control unit 3, the format control unit 6, the read channel 7, the head IC 8, the MPU 9, the memory 10, the program memory 11, and the servo control unit 12.

As illustrated in FIG. 2, the HDD 1 according to the present embodiment is connected with a host apparatus 100, such as a personal computer, through the host interface 18 which is not illustrated in FIG. 1.

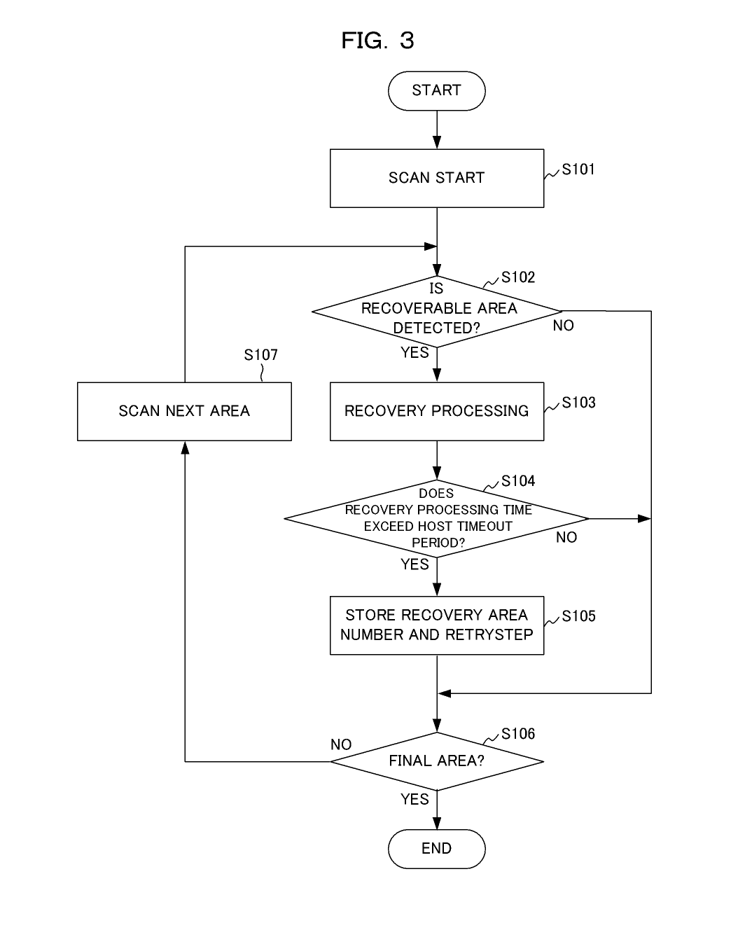

Now, the operation of the HDD according to the present embodiment will be described. FIG. 3 is a flowchart illustrating retry number saving processing. This processing uses Read Scan in SMART (Self-Monitoring, Analysis and Reporting Technology) Self Test. This Read Scan processing checks all the areas of the disk medium. While the areas are in units of sectors in the present embodiment, they may be divided in other unit areas.

Initially, the MPU 9 of the HDD 1 starts scanning the entire storage area of the disk medium 16 by Read Scan (S101, detection step). Having started scanning, the MPU 9 determines whether a recoverable area, a data area that can be accessed by retrying, is detected or not (S102, detection step).

If a recoverable area is detected (S102, YES), the MPU 9 performs recovery processing on the recoverable area (S103). In this recovery processing, retries are repeated until the data in the recoverable area (recovery unit area) is accessed. If the data in the recoverable area is accessed by the recovery processing, the MPU 9 determines whether or not the time taken for the recovery processing exceeds a host timeout period (S104, association step).

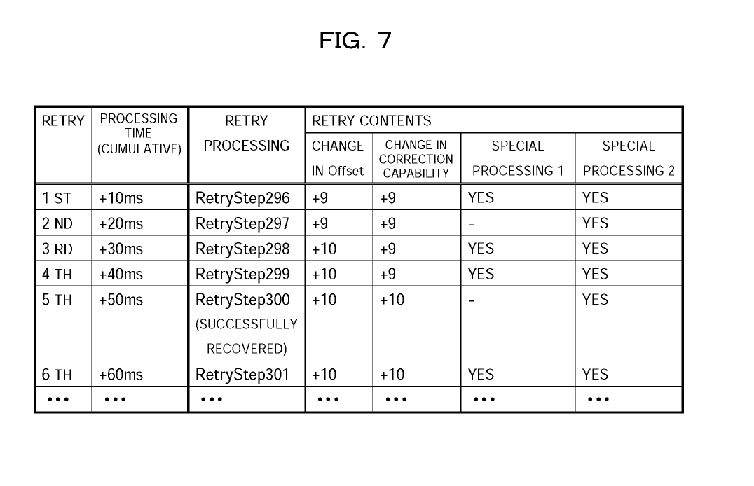

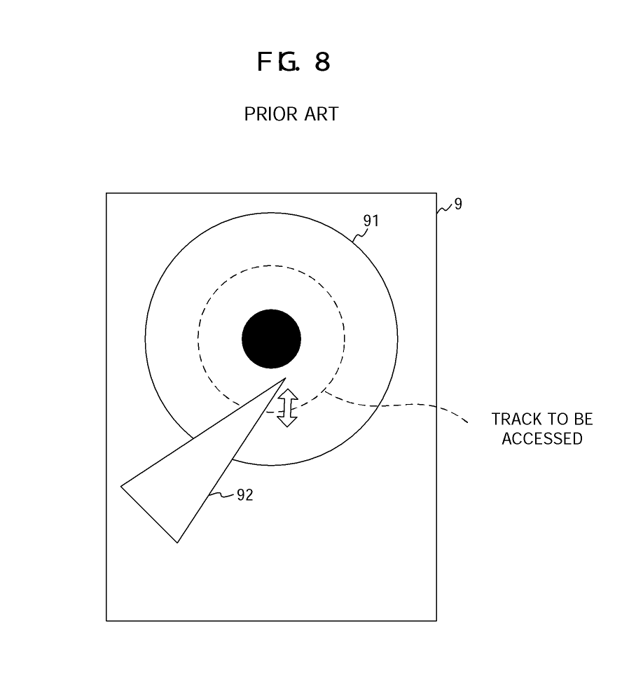

If the time taken for the recovery processing exceeds the host timeout period (S104, YES), the MPU 9 saves a recovery area number which indicates the recoverable area recovered by the recovery processing and a RetryStep at which the recoverable area is recovered, into the disk medium 16 or the nonvolatile memory 5 in association with each other (S105, association step). Having stored the recovery area number and the time (RetryStep) taken for the recovery processing, the MPU 9 determines whether or not the scanned area is the final area (S106). Note that the RetryStep refers to a parameter or correction value pertaining to retrying (retry parameter, retry content in FIG. 7). This RetryStep is configured in advance so that it increases in value (including the presence or absence of special processing 1 and special processing 2) as its order advances.

If the scanned area is the final area (S106, YES), the MPU 9 ends the processing.

On the other hand, if the scanned area is not the final area (S106, NO), the MPU 9 scans the next area (S107).

At step S104, if the time taken for the recovery processing does not exceed the host timeout period (S104, NO), the MPU 9 determines whether or not the scanned area is the final area (S106).

At step S102, if no recoverable area is detected (S102, NO), the MPU 9 determines whether or not the scanned area is the final area (S106).

By the foregoing operation, the HDD 1 can identify areas where the recovery processing time exceeds the host timeout period. The HDD 1 can also acquire the RetrySteps of the areas where the host timeout period is exceeded, by using Read Scan in SMART Self Test which is one of the functions implemented in the HDD 1. In the following description, an area where the recovery processing time exceeds the host timeout period will be referred to as a hard recovery area.

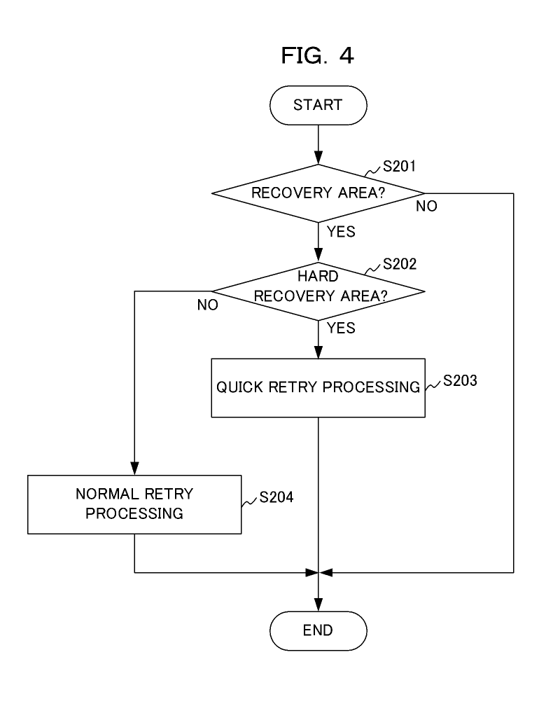

Next, description will be given of the retry processing. This retry processing is performed when the access target of an access command is a recovery area. FIG. 4 is a flowchart illustrating the operation of the retry processing.

Initially, the MPU 9 determines whether or not the access area the access command is targeted on is a recovery area (S201).

If the access area is a recovery area (S201, YES), the MPU 9 determines whether or not the access area is a hard recovery area (S202, retry start step).

If the access area is a hard recovery area (S202, YES), the MPU 9 performs quick retry processing to be described later (S203, retry start step).

On the other hand, if the access area is not a hard recovery area (S202, NO), the MPU 9 performs normal retry processing to be described later (S204).

At step S201, if the access area is not a recovery area (S201, NO), the MPU 9 ends the processing.

By the foregoing operation, the HDD 1 can perform different types of retry processing on hard recovery areas where the recovery processing time exceeds the host timeout period and on recovery areas where the recovery processing time does not exceed the host timeout period, respectively.

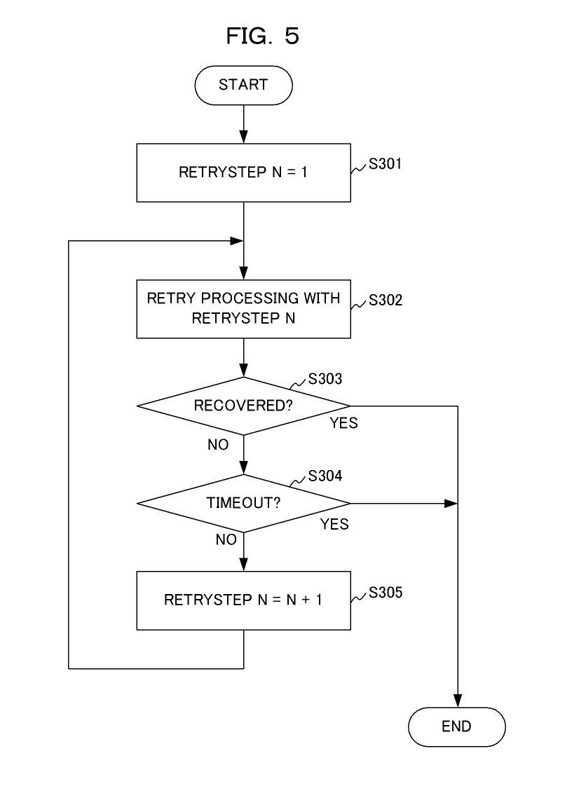

Next, the normal retry processing will be described. FIG. 5 is a flowchart illustrating the operation of the normal retry processing.

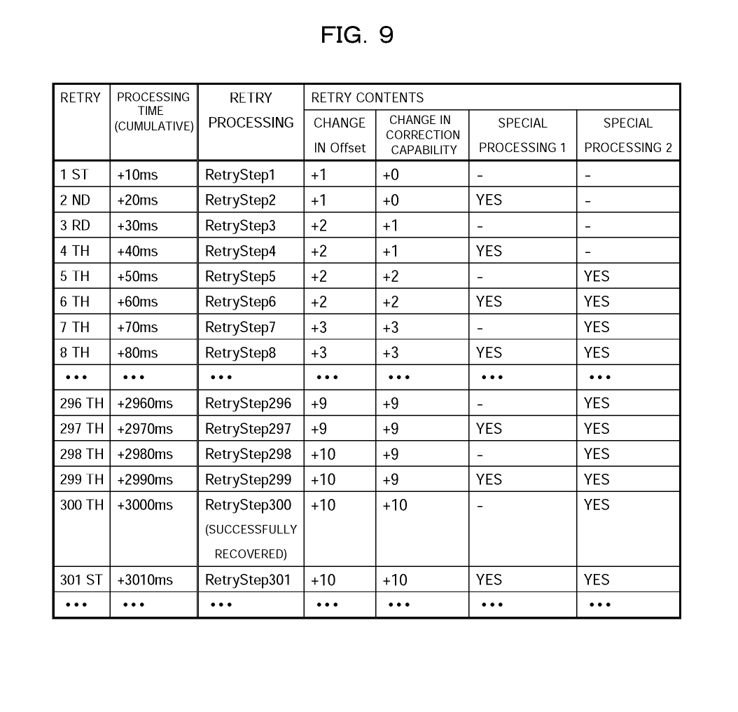

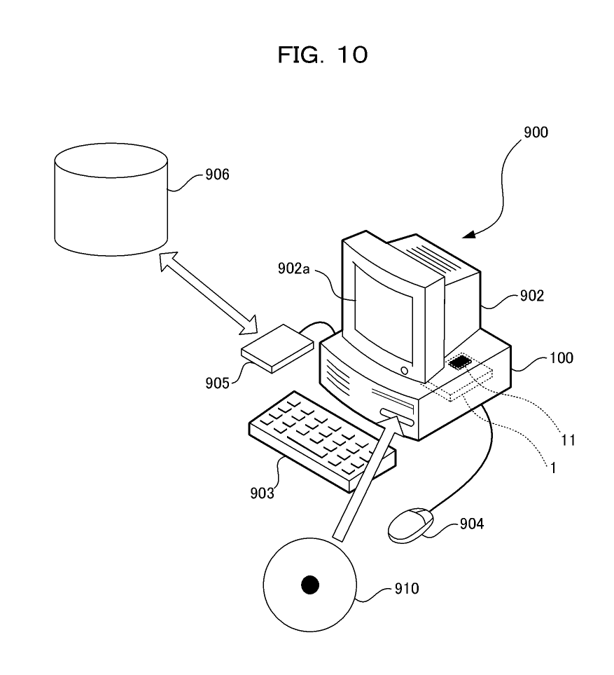

The MPU 9 initially substitutes 1 to a variable N (S301), where N is the RetryStep such as illustrated in FIG. 9. The MPU 9 performs retry processing on the recovery area with RetryStep N (S302). In the present embodiment, the processing contents (retry contents in FIG. 9) at the respective RetrySteps shall be determined in advance.

Next, the MPU 9 determines whether or not the recovery area is recovered (S303).

If the recovery area is not recovered (S303, NO), the MPU 9 determines whether or not a timeout occurs in the retry processing, i.e., the time taken for the retry processing exceeds the host timeout period (S304).

If no timeout occurs in the retry processing (S304, NO), the MPU 9 substitutes RetryStep N+1 into N (S305), and performs the retry processing on the recovery area again with RetryStep N (S302).

On the other hand, if a timeout occurs in the retry processing (S304, YES), the MPU 9 ends the normal retry processing.

At step S303, if the recovery area is recovered (S303, YES), the MPU 9 ends the normal retry processing.

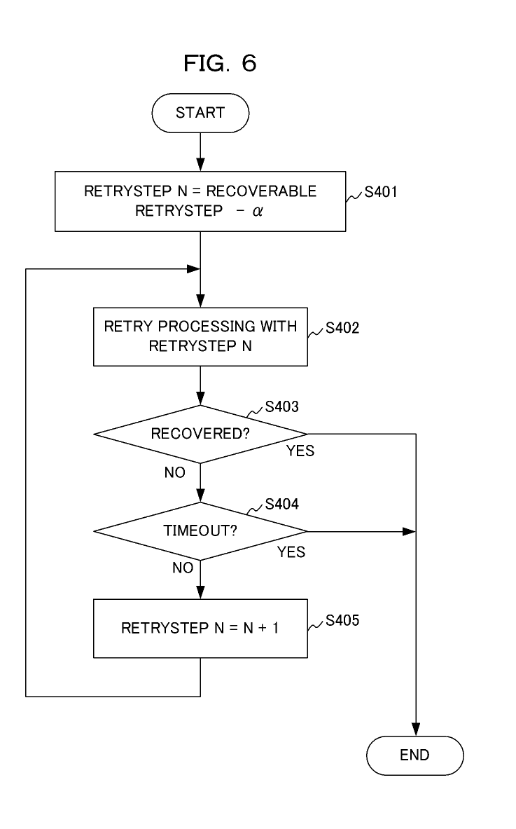

As described above, the normal retry processing executes retry processing from RetryStep 1 until the recovery area is recovered. In contrast, the quick retry processing executes retry processing from a predetermined RetryStep. FIG. 6 is a flowchart illustrating the operation of the quick retry processing. FIG. 7 is a chart illustrating the numbers of retries and the processing contents for the numbers of retries. Hereinafter, the operation of the retry processing illustrated in FIG. 6 will be described with reference to FIG. 7.

As illustrated in FIG. 6, the MPU 9 initially substitutes a RetryStep to the variable N, the RetryStep being determined by subtracting a predetermined value α from the RetryStep corresponding to the recovery area saved by the processing illustrated in FIG. 3 (S401, retry start step). For example, in the case of FIG. 7, the first round of retry processing is performed with a value that is obtained by subtracting a predetermined value α (predetermined number) of 4 from a RetryStep of 300 where the recovery by Read Scan was successful, i.e., with a RetryStep of 296. Note that the predetermined value α is changeable, being determined based on the host timeout period. More specifically, the predetermined value α and the host timeout period are proportional to each other. For example, the longer the host timeout period, the higher the predetermined value α. This allows the HDD 1 to increase the number of retries while avoiding timeout.

Next, the MPU 9 performs retry processing on the recovery area with RetryStep N (S402, retry start step).

Next, the MPU 9 determines whether or not the recovery area is recovered (S403).

If the recovery area is not recovered (S403, NO), the MPU 9 determines whether or not a timeout occurs in the retry processing, i.e., the time taken for the retry processing exceeds the host timeout period (S404).

If no timeout occurs in the retry processing (S404, NO), the MPU 9 substitutes RetryStep N+1 into N (S405), and performs the retry processing on the recovery area again with RetryStep N (S402).

On the other hand, if a timeout occurs in the retry processing (S404, YES), the MPU 9 ends the quick retry processing.

At step S403, if the recovery area is recovered (S403, YES), the MPU 9 ends the quick retry processing.

As described above, in an area where the time necessary for retry processing exceeds the host timeout period, the retry processing can be started from some steps before the successfully-recovered RetryStep that is stored in advance, thereby avoiding a timeout.

The present invention may be practiced in various other forms without departing from the gist or essential characteristics thereof. The foregoing embodiment is therefore to be considered in all respects as illustrative and not restrictive. The scope of the invention is indicated by the appended claims rather than by the foregoing description. All changes, improvements, substitutions, and modifications which come within the meaning and range of equivalency of the claims are also intended to be embraced in the scope of the invention.

The present invention is also applicable to a computer system such as described below. FIG. 10 is a diagram illustrating an example of the computer system to which the present invention is applied. The computer system 900 illustrated in FIG. 10 includes: a main unit 100 which is a host apparatus including a CPU and the HDD 1; a display 902 for displaying images under instructions from the main unit 100; a keyboard 903 for inputting various types of information to the computer system 900; a mouse 904 for designating an arbitrary point on a display screen 902a of the display 902; and a communication device 905 for accessing an external database and the like, and downloading programs and the like stored in other computer systems. Examples of the communication device 905 include a network communication card and a modem.

A program for causing a computer system including the HDD 1 such as described above to execute the foregoing steps may be provided as a retry program. This program is stored in a recording medium that is readable to the computer system so that it can be transferred from the main unit 100, the host apparatus, to the program memory 11 of the HDD 1 and executed by the HDD 1. The program for executing the foregoing steps may be stored in a portable recording medium such as a disk 910, or may be downloaded from a recording medium 906 of another computer system through the communication device 905. While the present embodiment has dealt with the case where the program memory 11 contains this program in advance, the program may be stored in a computer-readable recording medium such as the disk 910. Recording media readable to the computer system 900 include: internal storage devices which are implemented inside the computer, such as ROM and RAM; portable recording media such as the disk 910, flexible disk, DVD disk, magneto-optical disk, and IC card; databases for storing computer programs, and other computer systems and their databases; and various types of recording media accessible to a computer system that is connected via a communication unit such as the communication device 905.

The present invention provides the effect that timeout errors can be avoided when accessing error areas.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage apparatus for storing data in a storage area, comprising:
a detection unit that detects a recovery unit area in the storage area, the recovery unit area being a unit area recoverable by retrying;
an association unit that associates a unit area out of recovery unit areas detected by the detection unit, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and
a retry start unit that starts retrying to recover the unit area that requires the predetermined time or longer for recovery by the retrying, based on a retry parameter of order determined by subtracting a predetermined number from the order of the recovery parameter associated by the association unit with the unit area that requires the predetermined time or longer for recovery by the retrying.

2. The storage apparatus according to claim 1, wherein
the plurality of retry parameters ordered are configured to increase in value as the order advances.

3. The storage apparatus according to claim 1, wherein
the predetermined time is a command timeout period which is set in a host apparatus connected with the storage apparatus.

4. The storage apparatus according to claim 1, wherein
the detection unit detects the recovery unit areas by using Read Scan in SMART Self Test.

5. The storage apparatus according to claim 3, wherein
the predetermined number for the retry start unit to subtract from the order of the recovery parameter associated by the association unit with the unit area that requires the predetermined time or longer for recovery by the retrying is based on the command timeout period which is set in the host apparatus.

6. A medium containing a retry program in a computer-readable fashion, the retry program being executable by a computer in a storage apparatus for storing data in a storage area, the retry program causing the computer to execute:
detecting a recovery unit area in the storage area, the recovery unit area being a unit area recoverable by retrying;
associating a unit area out of recovery unit areas detected in the detection, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and
starting retrying to recover the unit area that requires the predetermined time or longer for recovery by the retrying, based on a retry parameter of order determined by subtracting a predetermined number from the order of the recovery parameter associated in the association with the unit area that requires the predetermined time or longer for recovery by the retrying.

7. The medium containing a retry program according to claim 6, wherein
the plurality of retry parameters ordered are configured to increase in value as the order advances.

8. The medium containing a retry program according to claim 6, wherein
the predetermined time is a command timeout period which is set in a host apparatus connected with the storage apparatus.

9. The medium containing a retry program according to claim 6, wherein
the detection includes detecting the recovery unit areas by using Read Scan in SMART Self Test.

10. The medium containing a retry program according to claim 8, wherein
the predetermined number to be subtracted in the starting of retrying from the order of the recovery parameter associated in the association with the unit area that requires the predetermined time or longer for recovery by the retrying is based on the command timeout period which is set in the host apparatus.

11. A retry method of a storage apparatus for storing data in a storage area, the method comprising:
detecting a recovery unit area in the storage area, the recovery unit area being a unit area recoverable by retrying;
associating a unit area out of recovery unit areas detected in the detection, the unit area requiring a predetermined time or longer for recovery by retrying, with a recovery parameter which is a retry parameter out of a group of a plurality of retry parameters which are ordered as correction values pertaining to the retrying, the recovery parameter making recovery possible of the unit area that requires the predetermined time or longer for recovery by the retrying; and
starting retrying to recover the unit area that requires the predetermined time or longer for recovery by the retrying, based on a retry parameter of order determined by subtracting a predetermined number from the order of the recovery parameter associated in the association with the unit area that requires the predetermined time or longer for recovery by the retrying.

12. The retry method according to claim 11, wherein
the plurality of retry parameters ordered are configured to increase in value as the order advances.

13. The retry method according to claim 11, wherein
the predetermined time is a command timeout period which is set in a host apparatus connected with the storage apparatus.

14. The retry method according to claim 11, wherein
the detection includes detecting the recovery unit areas by using Read Scan in SMART Self Test.

15. The retry method according to claim 13, wherein
the predetermined number to be subtracted in the starting of retrying from the order of the recovery parameter associated in the association with the unit area that requires the predetermined time or longer for recovery by the retrying is based on the command timeout period which is set in the host apparatus.
